(19) United States
(12) Patent Application Publication
(10) Pub. No.: US 2024/0339241 A1
(43) Pub. Date: Oct. 10, 2024

(54) FLEXIBLE FLAT CABLE

(71) Applicant: BELLWETHER ELECTRONIC CORP., Taoyuan City (TW)

(72) Inventors: HSING-YU LEE, Taoyuan City (TW); KUAN-WU CHEN, Taoyuan City (TW)

(21) Appl. No.: 18/745,053

(22) Filed: Jun. 17, 2024

Related U.S. Application Data
(63) Continuation-in-part of application No. 17/733,848, filed on Apr. 29, 2022.

(30) Foreign Application Priority Data
Mar. 7, 2022 (TW) 111108230

(51) Int. Cl. H01B 3/44; H01B 7/04; H01B 7/08

(52) U.S. Cl. CPC H01B 3/441; H01B 7/04; H01B 7/0823

(57) ABSTRACT

The present invention discloses a flexible flat cable, including a single low-dielectric mixed material layer, a plurality of conductor, two conductive material layers and two insulating protective layers. These conductors are located inside the single low-dielectric mixed material layer and are spaced apart. The two conductive material layers are laminated individually to the upper and lower surfaces of the single low-dielectric mixed material layer. The two insulating protective layers are laminated individually to the two conductive material layers.

### CROSS REFERENCE TO RELATED APPLICATIONS

This application is a Continuation-in-Part of co-pending application Ser. No. 17/733,848, filed on Apr. 29, 2022, for which priority is claimed under 35 U.S.C. § 120; and this application claims priority of application Ser. No. 11/110,8230 filed in Taiwan on Mar. 7, 2022 under 35 U.S.C. § 119, the entire contents of all of which are hereby incorporated by reference.

### BACKGROUND OF THE INVENTION

### 1. Field of the Invention

The present invention relates to a cable, in particular to a flexible flat cable with folding endurance.

### 2. Description of the Related Art

According to the characteristic impedance formula of the strip line, it is known that the dielectric constant and thickness of a dielectric material layer located between two conductive material layers, and the size of a strip line located within the dielectric material layer, will affect the characteristic impedance of the strip line. Therefore, in order to ensure uniform characteristic impedance of a row of signal lines (i.e., strip lines) in a flexible flat cable (FFC) and to avoid or reduce the return loss and insertion loss caused by uneven impedance distribution, it is necessary to find a way to maintain uniform spacing and dielectric constant between the two conductive material layers. In other words, regardless of the operating condition of the FFC, the dielectric material layer between the two conductive material layers must have sufficient adhesion to maintain consistent spacing and dielectric constant between the two conductive material layers.

However, the two conductive material layers are usually bonded to the upper and lower surfaces of the dielectric material layer respectively by a quite thin adhesive layer in a traditional FFC. When the FFC is folded, at the folded area, some parts between the two conductive material layers and the dielectric material layer may come off due to uneven adhesion or insufficient adhesion of the adhesive layer. This may result in inconsistent spacing between the two conductive material layers, affecting the uniformity of the dielectric material layer thickness between them. Moreover, the dielectric material layer itself may lack sufficient flexibility, resulting in cracks or fissures at the folded area, causing the localized variations in the dielectric constant between the two conductive material layers. This indicates that the characteristic impedance of the signal lines of the FFC at the folded area will lose its original uniformity, and cause the signal lines an enlargement of return loss, which further affects insertion loss, causing the transmission characteristics of the signal lines to deteriorate. In other words, before the FFC is folded, the signal lines possess even characteristic impedance, but once it's folded, the characteristic impedance of the signal lines will be distributed unevenly and thus unable to maintain good transmission characteristic.

Therefore, providing an FFC that can still maintain good transmission characteristics after being folded is an urgent need.

### SUMMARY OF THE INVENTION

It is the object of the present invention to provide a flexible flat cable (FFC) to solve the aforementioned problem. More specifically, the flexible flat cable of the present invention comprises a single low-dielectric mixed material layer, a plurality of conductors, two conductive material layers, and two insulating protective layers. The single low-dielectric mixed material layer includes a mixture of Maleic Anhydride grafted Polyolefin Elastomer (MAH-g-POE) and Polyolefin Elastomer (POE). These conductors are located inside the single low-dielectric mixed material layer and arranged side by side with space in between. The two conductive material layers are laminated individually and directly to upper and lower surfaces of the single low-dielectric mixed material layer. The two insulating protective layers laminated individually to the two conductive material layers.

In one preferred embodiment, the Maleic Anhydride (MAH) content of the aforementioned MAH-g-POE is 0.01˜2%.

In one preferred embodiment, the single low-dielectric mixed material layer is composed of a low dielectric constant POE mixed with 30˜100 wt % MAH-g-POE.

In one preferred embodiment, the adhesion between the single low-dielectric mixed material layer and each conductive material layer is greater than or equal to 20 N/mm.

In one preferred embodiment, the melt flow index of the single low-dielectric mixed material layer is 10˜40 g/10 min.

In one preferred embodiment, the dielectric constant of the single low-dielectric mixed material layer is 1.5-3.

In one preferred embodiment, the melting point of the single low-dielectric mixed material layer is 95-180° C.

In one preferred embodiment, the specific gravity of the single low-dielectric mixed material layer is 0.85-0.9.

In one preferred embodiment, the operating temperature of the single low-dielectric mixed material layer is-50-150° C.

In one preferred embodiment, the Shore A hardness of the single low-dielectric mixed material layer is 50-90.

In one preferred embodiment, the water absorption of the single low-dielectric mixed material layer is 0.001-1%.

In one preferred embodiment, a thickness of the single low-dielectric mixed material layer is 100-450 μm.

In one preferred embodiment, a cross-sectional shape of each of the conductors is circular, with a diameter being 25-40 AWG, an internal impedance being 65-110 ohms, and a center-to-center distance between two adjacent conductors being 0.3-0.8 mm.

In summary, compared with the prior art, the insertion loss and characteristic impedance of the flexible flat cable of the present invention do not change significantly before and after the cable is folded, thereby allowing the cable to maintain its original good transmission characteristics when folded, thus solving the problem with conventional flexible flat cable being unable to maintain good transmission when the cable is folded.

### BRIEF DESCRIPTION OF THE DRAWINGS

FIG. 1 is an enlarged schematic partial cross-sectional view of a preferred embodiment of the FFC of the present invention;

FIG. 2 is a schematic plan view of the preferred embodiment of the present invention;

FIG. 3 is a schematic plan view of the preferred embodiment of the present invention being folded into an N shape;

FIG. 4 is a schematic diagram depicting the fabrication of the preferred embodiment of the present invention;

FIG. 5 is an enlarged partial cross-sectional view of the polyester insulating tape body 100 of the preferred embodiment of the present invention;

FIG. 6 is an insertion loss vs. frequency graph for the preferred embodiment of the present invention when it is not yet folded and when it is folded into an N shape;

FIG. 7 is a characteristic impedance vs. time graph for the preferred embodiment of the present invention when it is not yet folded and when it is folded into an N shape.

### DETAILED DESCRIPTION OF EMBODIMENTS

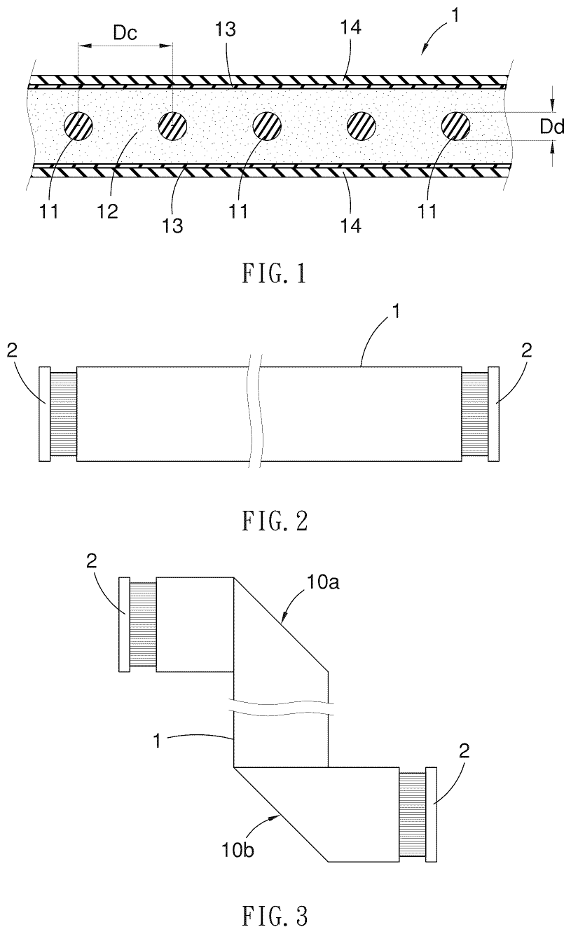

FIG. 1 and FIG. 2 are schematic views showing a preferred embodiment of the FFC 1 of the present invention. Each of the two ends of the cable has an electrical connector 2, and the two electrical connectors 2 are used for plugging individually into two electronic devices (not shown in the figures), so that the two electronic devices can transmit signals through the FFC 1. Any of said electrical connectors 2 can also be connected with corresponding mating electrical connectors to form an electrical connection. In addition, FIG. 3 shows a possible usage of the FFC 1, in which the FFC 1 is folded into an N shape so as to form a first folded edge 10a and a second folded edge 10b.

As shown in FIG. 1, the layered structure of the FFC 1 of the present invention includes a single low-dielectric mixed material layer 12, a plurality of conductors 11 located inside the single low-dielectric mixed material layer 12 and arranged side by side with space in between, two conductive material layers 13 laminated individually and directly to the upper and lower surfaces of the single low-dielectric mixed material layer 12, and two insulating protective layers 14 laminated to the two conductive material layers 13, wherein there conductors 11 form a row of signal lines for transmitting differential signal.

The single low-dielectric mixed material layer 12 is a single layer, meaning, the entire layer consists of the same mixed material. There is no other material layer between the conductors 11 and the single low-dielectric mixed material layer 12. Furthermore, the single low-dielectric mixed material layer 12 is insulated and has adhesive and elastic properties and low dielectric constant.

In one preferred embodiment, the single low-dielectric mixed material layer 12 includes one or more low dielectric constant POE and MAH-g-POE. After the aforementioned POE and MAH-g-POE are evenly mixed, it forms the above-mentioned single low-dielectric mixed material layer 12. The crystallinity of the aforementioned low dielectric constant POE is high, thus having hard, brittle and low fluidity characteristics. The dielectric constant of MAH-g-POE is relatively high but has low-crystallinity (or is a type of amorphous material), thus having high elastic and supple characteristics. In other words, relative to the low dielectric constant POE mentioned above, although the dielectric constant of the MAH-g-POE is higher, but due to its higher elasticity it is less hard and less brittle, and the adhesion of the MAH-g-POE is also higher than the POE mentioned above. Therefore, the single low-dielectric mixed material layer 12, having the aforementioned POE and MAH-g-POE, not only can it maintain low dielectric constant, lower the overall crystallinity, while possessing good adhesion as well as excellent elasticity.

In one preferred embodiment, the MAH content of the aforementioned MAH-g-POE is 0.01˜2%, that is to say, in this material, the grafting ratio of MAH being grafted onto Polyolefin is 0.01˜2%.

In another preferred embodiment, the weight percentage of the low dielectric constant POE of the single low-dielectric mixed material layer 12 is preferably 0˜70, and the weight percentage of the MAH-g-POE of the single low-dielectric mixed material layer 12 is preferably 30˜100. In short, the single low-dielectric mixed material layer 12 is made up of a mixture of 0˜70 wt % low dielectric constant POE and 30˜100 wt % MAH-g-POE, so that the single low-dielectric mixed material layer 12 has good adhesion, insulation, high elasticity, low crystallinity and low dielectric constant.

Moreover, by adding MAH-g-POE (e.g., added to the above mentioned ratio), the adhesion (or peel strength) between the single low-dielectric mixed material layer 12 and the two conductive material layers 13 are increased from below 0.5 N/mm to greater or equal to 20 N/mm, this could also lower the heat of fusion of the single low-dielectric mixed material layer 12. This shows that as a macromolecule material, the crystallinity of POE will be reduced with the addition of the MAH-g-POE, so that the single low-dielectric mixed material layer 12 of a mixture of the aforementioned materials will have improved flexibility (i.e., better softness and extensibility) as a result of the increase of the non-crystalline region. In addition, the single low-dielectric mixed material layer 12 has at least one or more of the following properties:
Dielectric constant (Dk): 1.5-3;
Adhesion (N): N≥20 N/mm;
Melt Flow Index (MI): 10-40 g/10 min (under the conditions of material weight at 16 Kg, and melting temperature at 90° C.);
Melting point: 95-180° C.;
Specific Gravity: 0.85-0.9;
Shore A hardness: 50-90;
Dissipation factor (Df): 0.0001-0.01;
Operating temperature: −50-150° C. (maximum withstanding temperature);
Water absorption: 0.001-1%.

The thickness of the single low-dielectric mixed material layer 12 is preferably, but not limited to, 100-450 μm+10 μm.

The cross-sectional shape of each of the conductors 11 can be circular, rectangular, square or other shapes. In this preferred embodiment, the cross-sectional shape of each of the conductors 11 is circular with a diameter

Dd being preferably 25-40 AWG, internal impedance being preferably 65-110 ohms, and a center-to-center distance between two adjacent conductors 11 being preferably 0.3-0.8 mm.

The thickness of each of the conductive material layers 13 is preferably 0.003-0.020 mm, wherein, each conductive material layer 13 can be used as a shielding layer which provides electromagnetic shielding.

Each of the conductors 11 and each of the conductive material layers 13 are made of conductive materials, such as copper, silver, aluminum, gold or alloys thereof, but not limited thereto. An inner surface of each conductive material layer 13 is respectively superimposed onto an upper surface and a lower surface of the single low-dielectric mixed material layer 12, and there is no other material layer between the inner surface of each conductive material layer 13 and the upper and lower surfaces of the single low-dielectric mixed material layer 12, so there there's only the single low-dielectric mixed material layer 12 and the conductors 11 between the two conductive material layers 13.

The thickness of each of the insulating protective layers 14 is preferably 0.005-0.05 mm, and the material thereof is preferably thermoplastic or thermosetting insulating material. In addition, each of the insulating protection layers 14 can be bonded to the adjacent conductive material layers 13 by an adhesive layer (not shown in the figures).

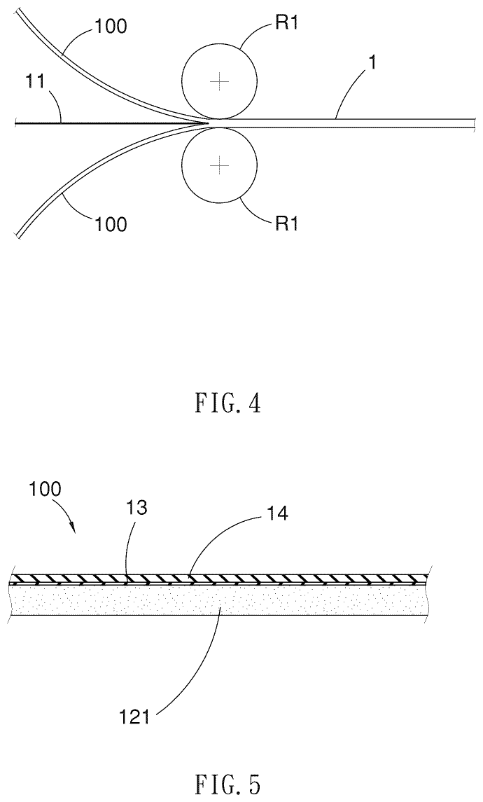

FIG. 4 shows that the conductors 11 are introduced between the two pre-fabricated polyester insulating tape bodies 100, and then the two polyester insulating tape bodies 100 are pressed by two hot press rollers R1 to obtain the FFC 1 of the present invention. As shown in FIG. 5, the layered structure of each polyester insulating tape body 100 includes a layer of the insulating protection layer 14, a layer of the conductive material layer 13 and a layer of the low-dielectric mixed material layer 121. The conductive material layer 13 is sandwiched between the other two, preferably the conductive material layer 13 being directly laminated to a surface of the low-dielectric mixed material layer 121, the insulating protection layer 14 being laminated to an outer surface of the conductive material layer 13, and that there is no other material layer between the conductive material layer 13 and the low-dielectric mixed material layer 121.

When the conductors 11 arranged side by side with space in between are introduced between the two polyester insulating tape bodies 100, the low-dielectric mixed material layer 121 of one of the polyester insulating tape bodies 100 faces an upper surface of each of the conductors 11, while the low-dielectric mixed material layer 121 of the other polyester insulating tape body 100 faces a lower surface of each of the conductors 11. Therefore, when two of the polyester insulating tape bodies 100 are pressed by the two hot press rollers R1, the low-dielectric mixed material layer 121 of one of the polyester insulating tape bodies 100 will be bonded to the low-dielectric mixed material layers 121 of the other polyester insulating tape body 100, so that the conductors 11 are surrounded by two of the low-dielectric mixed material layers 121; in other words, the conductors 11 are located inside the single low-dielectric mixed material layer 12 formed by two of the low-dielectric mixed material layers 121. The materials used in the two low-dielectric mixed material layers 121 are the same as the single low-dielectric mixed material layer 12, thus we will not go into further detail.

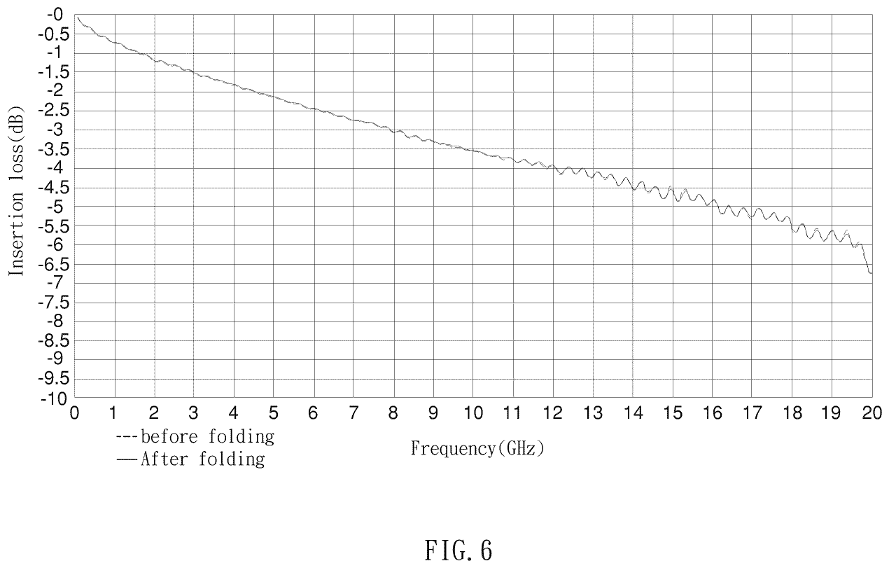

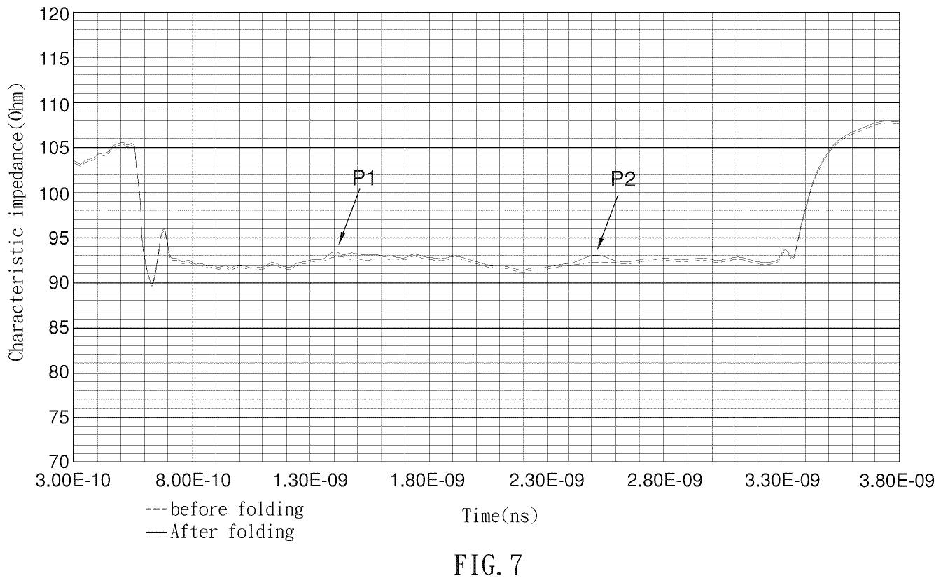

As it can be seen from above, in the present invention the single low-dielectric mixed material layer 12 and each conductive material layers 13 are directly bonded, without any other material layer (e.g.: adhesive layer) in between. Furthermore, not only does the single low-dielectric mixed material layer 12 of the present invention has low dielectric constant, it also possesses good adhesion, high elasticity, and low crystallinity, which makes the single low-dielectric mixed material layer 12 less prone to cracking due to folding. Therefore, the FFC 1 of the present invention has good flexibility and high tolerance for folding; this can be proved by the diagram shown in FIGS. 6 and 7.

FIG. 6 shows an insertion loss vs. frequency graph for said FFC 1 of the present invention when it is not folded and when it is folded into an N shape (see FIG. 3). It can be seen from the figure that the two curves almost overlap, which means that the insertion loss of said FFC 1 of the present invention does not decrease significantly when it is folded into an N shape compared to the insertion loss when it is not folded. This shows that regardless of the frequency, the insertion loss of the conductors 11 of said FFC 1 of the present invention is not affected even when the cable is folded. t

FIG. 7 shows a characteristic impedance vs. time graph for FFC 1 of the present invention when it is not folded and when it is folded into an N shape (see FIG. 3). It can be seen from the figure that at the two positions P1 and P2 corresponding to said first folded edge 10a and said second folded edge 10b, the maximum change in the characteristic impedance is only about 1 ohm. This shows that not much impedance change is caused even when the FFC 1 of the present invention is folded.

Regarding the above descriptions, the conductor of the present invention is located inside a single low-dielectric mixed material layer, the two conductive material layers being directly laminated to the upper and lower surfaces of the single low-dielectric mixed material layer, and a protective layer is laminated to each of the conductive material layers. Therefore, between each of the conductive material layers and the conductors, there is no film layer of other materials except the single low-dielectric mixed material layer therebetween. As such, the insertion loss and characteristic impedance of the conductors 11 of said FFC 1 of the present invention do not change significantly before and after the cable is folded, thereby allowing the cable to maintain its original good transmission characteristics when folded.

What is claimed is:

1. A flexible flat cable (FFC), comprising:
a single low-dielectric mixed material layer included a mixture of Maleic Anhydride grafted Polyolefin Elastomer (MAH-g-POE) and Polyolefin Elastomer (POE);
a plurality of conductors which are spaced apart sheathed in the single low-dielectric mixed material layer, and there is no other material layer between each conductor and the single low-dielectric mixed material layer;
two conductive material layers, an inner surface of each conductive material layer laminated individually and directly to upper and lower surfaces of the single low-dielectric mixed material layer, wherein there is no other material layer between each conductive material layer and the single low-dielectric mixed material layer, so that there is only the single low-dielectric mixed material layer and the conductors between the two conductive material layers, and
two insulating protective layers laminated individually to an outer surface of each conductive material layer.

2. The FFC as recited in claim 1, wherein the Maleic Anhydride (MAH) content of the Maleic Anhydride grafted Polyolefin Elastomer (MAH-g-POE) is 0.01˜2%.

3. The FFC as recited in claim 2, wherein the single low-dielectric mixed material layer is composed of a 0˜70 wt % low dielectric constant Polyolefin Elastomer (POE) mixed with 30˜100 wt % Maleic Anhydride grafted Polyolefin Elastomer (MAH-g-POE).

4. The FFC as recited in claim 2, wherein the adhesion between the single low-dielectric mixed material layer and each conductive material layer is greater than or equal to 20 N/mm.

5. The FFC as recited in claim 2, wherein the melt flow index of the single low-dielectric mixed material layer is 10˜40 g/10 min.

6. The FFC as recited in claim 2, wherein the dielectric constant of the single low-dielectric mixed material layer is 1.5-3.

7. The FFC as recited in claim 2, wherein the melting point of the single low-dielectric mixed material layer is 95-180° C.

8. The FFC as recited in claim 2, wherein the specific gravity of the single low-dielectric mixed material layer is 0.85-0.9.

9. The FFC as recited in claim 2, wherein the operating temperature of the single low-dielectric mixed material layer is −50-150° C.

10. The FFC as recited in claim 2, wherein the Shore A hardness of the single low-dielectric mixed material layer is 50-90.

11. The FFC as recited in claim 2, wherein the water absorption of the single low-dielectric mixed material layer is 0.001-1%.

12. The FFC as recited in claim 2, wherein a thickness of the single low-dielectric mixed material layer is 100-450 μm.

13. The FFC as recited in claim 2, wherein a cross-sectional shape of each of the conductors is circular, with a diameter being 25-40 AWG, an internal impedance being 65-110 ohms, and a center-to-center distance between two adjacent conductors being 0.3-0.8 mm.
